(19) United States
(12) Patent Application Publication
(10) Pub. No.: US 2019/0035162 A1
(43) Pub. Date: Jan. 31, 2019

(54) 3-D OBJECT DESIGN

(71) Applicant: MXX1 Holdings Pty Ltd., Brisbane (AU)

(72) Inventor: Ian Maxwell, Brisbane (AU)

(73) Assignee: MXX1 Holdings Pty Ltd, Brisbane (AU)

(21) Appl. No.: 16/044,530

(22) Filed: Jul. 25, 2018

(30) Foreign Application Priority Data
Jul. 26, 2017 (AU) 2017902929

(51) Int. Cl. G06T 19/20; G06T 17/10; G06F 17/50; G06F 3/0484; G06F 3/0488

(52) U.S. Cl. CPC G06T 19/20; G06T 17/10; G06F 3/0488; G06F 3/04845; G06F 17/50

(57) ABSTRACT

Computer-implemented tool boxes and related methods are described. An exemplar computer-implemented method includes: (1) displaying a representation of template 3-D shape of an object for design on a device having a touch-sensitive display, the object for design having one or more modifiable features; (2) selecting a feature for modification by detecting a touch gesture input that comprises the touch of a finger or a pointing device on the relevant part of the image displayed on the touch-sensitive display; (3) modifying the feature once selected by repeated touch gestures on the relevant part of the image, wherein the touch gestures are used to select one of colour, size of any of the x,y,z dimensions, shape, radius, any other size related dimension, shape, orientation or position with respect to other objects; and (4) visually displaying the options available for selection in relation to one of colour, size, shape, orientation or position.

### TECHNICAL FIELD

The present invention relates to the design of 3-D objects using computer software.

### BACKGROUND

There are many software products available that allow users to design 3-dimensional (3-D) objects on a computer. These software tools are usually enterprise (PC apps) software, web-browser based software or smartphone apps, and in almost all cases suffer from usability issues.

Most software tools require the incorporation of menus within the software, usually of the pull-down variety and/or of the toolbox variety. Within each menu item a specific function can be labelled with a word and/or a picture. Together with mouse movements and clicks or equivalent touch gestures, these menu choices are the primary user features of just about all 3-D design tools available on the market.

A problem with most software packages incorporating software tools is that the degree of complexity of features is such that substantial scholarship is required to master the tools. There are even tertiary courses focused entirely on the use of these complex software tools. Even with the appropriate training the effective use of the software tools may require constant use to maintain the operator skills.

At the other end of the spectrum there are some very simple 3-D design packages available for low cost or for free (some using a web browser interface) that have a very cut-down set of functionalities as compared to the complex software packages described above. However, even these cut-down packages typically still require mouse-driven or equivalent touch-driven processes with menu items and tool-bars. By making the program simpler to use, the trade-off is simply that the easier-to-use program can only be used to design a small fraction of the 3-D objects that a more complex package can be used to design.

It is desirable to make design software tools that are easy to use without requiring special training other than instruction by example and optionally by trial and error.

### SUMMARY OF THE DISCLOSURE

A computer-aided design toolbox for interactively designing a 3-D model on a device having a touch-sensitive display, said computer-aided design toolbox comprising:

an image of a template 3-D shape incorporating at least one object that can be selected for design by touch-gesture on the touch-sensitive display;

the object, once selected, having one or more visually indicated modifiable features that can each be modified by further touch gestures on the touch-sensitive display;

wherein the further touch gestures on the relevant part of the image are used to modify one of colour, size of any of the x,y,z dimensions, shape, radius, any other size related dimension, shape, orientation with respect to other objects, or position with respect to other objects, of each modifiable feature;

wherein further touch gestures include single tap, double tap, and multiple tap gestures, pinch and zoom, slide, swipes in any direction, pressure sensitive touch, and any other commonly used touch gestures as enabled on a device;

wherein each of the modifiable features is visually displayed on the touch sensitive display during modification so that the user does not have to remember what they are doing; and

wherein only one of the modifiable features is displayed at any moment and wherein a modifiable features can be purposefully varied by touch-driven 3-D rotation of the selected object.

An advantage of the invention may be the design of a 3-D model on a device using touch gestures initiated by visual indicators, without the need for a complex set of menus and toolboxes. The design of the 3-D model may be effected through a consistent series of touch selections, which the user can learn and then intuit. The user may come to quickly understand the functionality of the design tool through useage and experience, rather than through scholarship.

In a second aspect of the present invention, there is provided a computer-aided design tool for interactively designing a 3-D model on a device, optionally a mobile device, having a touch-sensitive display, said computer-aided design tool comprising software program code stored on a server computer and executable by the device accessing the code, the software program code including:
a. scripting software code for generating an image of template 3-D shape of an object selected for design, the object or part thereof once selected having one or more modifiable features that can each be selected for modification by touch gesture on the relevant part of the image displayed on the touch-sensitive display;
b. scripting software code for visually indicating which are the one or more modifiable features of the image that are available for selection;
c. scripting software code for modifying each of the modifiable features once selected, the modifications each effected by repeated touch, slide and/or by pinch and expand touch gestures, wherein the touch gestures on the relevant part of the image are used to select one of colour, size, shape, orientation or position of each modifiable feature;
d. once a modifiable feature is selected, scripting software code for visually displaying the options available for selection in relation to one of colour, size, shape, orientation or position;
wherein the modification selections are saved as project data.
   Optionally there is further:
e. 3-D assembly software code for preparing a 3-D computer aided model based on the project data.

In its broadest form there is disclosed herein a computer-aided design toolbox for interactively designing a 3-D model on a device having a touch-sensitive display, said computer-aided design toolbox comprising:

an image of a template 3-D shape of an object for design, at least a part of the object having one or more modifiable features that can each be selected for modification by touch gesture on the relevant part of the image displayed on the touch-sensitive display;

wherein the touch gestures on the relevant part of the image are used to select one of colour, size, shape, orientation or position of each modifiable feature; the modification selections being saved as project data.

The computer-aided design tool and toolbox can be particularly advantageous when used on a touch enabled device such as a smartphone, a tablet or a touch PC. Touch screens are becoming increasingly popular because of their ease and versatility of operation as well as their declining price. Touch screens can include a touch sensor panel, which can be a clear panel with a touch-sensitive surface. The touch sensor panel can be positioned in front of a display screen so that the touch-sensitive surface covers the viewable area of the display screen. Touch screens can allow a user to make selections and move a cursor by simply touching the display screen via a finger or stylus. Whilst touch is described herein, mouse movements that can replicate touch, by way of general extension are included within the spirit and scope of this disclosure. In general, the touch screen can recognize the touch and position and sometime pressure of the touch on the display screen, and a computing system can interpret the touch and thereafter perform an action based on the touch event. Touch screens can be found on fixed or immobile devices such as ticket machines, vending machines, white goods. Touch screens are also found on mobile devices which can be transported from one location to another, usually with the user. In one embodiment, the design tool of the present invention is operable on a mobile device.

The design tool can comprise software program code that is stored on the device itself. The design tool can comprise a software program code that is stored outside of the device itself. This may be necessary when the storage capacity or processing power of the device, such as a mobile device, is less than that is required by the software program itself. The software program may be stored in a virtualised computing environment such as a server. Virtualized computing environments, also referred to as cloud computing systems or composite information technology systems, are used to provide computing resources to end users. Cloud computing systems may include servers, network storage devices, routers, gateways, communication links, software (e.g., applications, operating systems, web services, etc.), and other devices. However, because the physical hardware and software platforms on which cloud computing system is implemented are hidden within a “cloud,” they can be managed, upgraded, replaced or otherwise changed by a system administrator without the customer being aware of or affected by the change. This type of distributed computing allows one machine to delegate some of its work to another machine that might be, for example, better suited to perform that work. For example, the server could be a high-powered computer running a database program managing the storage of a vast amount of data, while the client is simply a mobile device which requests information from the database to use in one of its local programs. In a cloud computing environment, the physical hardware configuration is hidden from the end user.

The scripting software code can be program code or coding that instructs the software program to undertake certain functions. The software can comprise code for generating an image of a template 3-D shape of an object selected for design. The 3-D design application technology can be applied to any ‘constrained’ design problem. In most cases however, it cannot be used to do ‘clean sheet’ design. By this it is meant that there should preferably be a library of template objects for design to start, and a limited set of pre-determined dimensions, shapes and colours that can be manipulated by the user. The 3-D shape of the object can be simulated as the basic template shape of an object. The template is a basic shape or a starting shape, which can be modified in a variety of ways. The 3-D model template has graphic and database characteristics:

(1) Boundary representation, which are the physical shape and size of the components which form the template 3-D shape of the object in all three spatial dimensions. The boundary representation not only defines the exterior surface of the object but also the space within the object.

(2) Parametric properties, which allow certain components to be modified to change their shape, colour and size within certain tolerances. The tolerances that restrict the parametric properties can be manufacturing capabilities and availabilities, code requirements, and component manufacturing costs.

(3) Connection properties, which define how and where components of the object are connected to other components.

(4) Orientation properties define how components are arranged in all three spatial dimensions. Several factors influence the orientation properties including gravity, constructability, and operability.

(5) Movement properties define how components of the object are intended to move in all three spatial dimensions. These may include radial sweep like an arm of a pair of spectacles, single axis slide or multi-axis flex and bend like a structural element.

(6) Element name and description properties are labels that define the component and the associated properties. These names may be represented on the image of the object, or they may simply be a part of the scripting code.

In the software program as described herein the graphic and database properties are preferably described by analytically solved mathematical equations for calculational efficiency. Alternatively a finite element approach can be used.

The template of the 3-D object can be anything that lends itself to design. There may be a library of generic template designs. The image of the template 3-D shape may incorporate a number of objects (including one or two or three or more objects) and at least one of those objects can be selectable for design by touch-gesture on the touch-sensitive display. The object, once selected, can have one or more visually indicated modifiable features that can each be modified by further touch gestures on the touch-sensitive display. Customisation of the object through modification of the features can be for any reason including functionality, aesthetics, or simple preference for certain features. It is becoming increasingly common for e.g. fashion designers to prototype high-fashion jewellery such as bracelets as computer files. The jewellery may comprise a model for a plain ring-shaped bracelet or ring which may have modifiable features modifiable to have various widths, wrist sizes or radius, and thicknesses suitable to different materials. The object may be a watch having modifiable features selected from e.g. case, lugs, bezel, crown, face, face indicators and hands. The object may be a pair of spectacles which might include designer sunglasses, and the modifiable features may be selected from arms, frame, bridge, lenses.

An example of a process that may result in a new template for a 3-D object may be:
1. An entity is interested in building a software application to allow people to design their own version of a 3D object (such as jewellery, glasses, shoes, tools, watches, spoons, bottle openers (use your imagination)).
2. The entity undertakes a desk-top study and comes up with a list of specifications for the constrained design problem that will allow their customers to design a range of objects.
3. The template is first mathematically defined by equations or alternatively constructed from a finite element model. These equations or models are then inserted into the software that defines the user application.

The 3-D object can be manipulable on the screen by touch gesture. As the template 3-D shape of the object is caused to rotate optionally in all three spatial dimensions, various visual indicators can indicate parts of the template of the object that are available for modification. The visual indicators can be any one of arrows, colours, flashes, or other indicia intended to capture the user's eye. If there are no visual indicators, the user may have to tap on the object as a whole in order to find which parts of the object are reactive and available for modification. This is not preferred and instead, indicators may be provided to allow the user to quickly assess and modify the features of the object that they want to customise.

The modifications can be of any one of the parametric properties of the object, e.g. to change the shape, colour and size within certain tolerances. In relation to a watch, for example, the modifications may be to change the dimensions, colour, thickness, profile.

To make a selection, the user makes touch gestures on the touch-sensitive display. The device may detect contact with the touch screen. The device may also be able to determine if there is movement of the contact and track the movement of that contact across the touch screen. The device may be able to determine if the contact has been broken (i.e. if the contact has ceased). Determining movement of the point of contact may include determining speed (magnitude), velocity (magnitude and direction), and/or an acceleration (a change in magnitude and/or direction) and/or pressure of the point of contact. These operations may be applied to single contacts (e.g. one finger contact) or to multiple simultaneous contacts (e.g. “multitouch”/multiple finger contacts). A selection may be made by making contact with or touching a modifiable feature represented on the object displayed, for example, with one or more fingers or a stylus. In some embodiments, selection occurs when the user breaks contact with the one or more modifiable features. In some embodiments, the contact may include a gesture, such as one or more taps, one or more swipes (from left to right, right to left, upward and/or downward) and/or a rolling of a finger (from right to left, left to right, upward and/or downward) that has made contact with the device. In some embodiments, inadvertent contact with a graphic may not select the graphic. For example, a swipe gesture that sweeps over an application icon may not select the corresponding application when the gesture corresponding to selection is a tap. Preferably, the gestures available are limited in number and are consistently used throughout the design process so that a user will quickly learn the functionality and can then guess through useage rather than requiring instructions.

The 3-D object can be constrained in an area larger than the visual field of the device (screen). If the 3-D object is moved e.g. by swiping, it can move off the screen of the device, and then bounce once it hits a boundary and return towards the centre of the screen optionally for further manipulation.

The modification selections are saved as project data. The project data comprises all of the selections made by the user in relation to the modifiable features. The project data may simply be a 3-D design for use in software applications with no intent with respect to fabrication of an object. Alternatively, there is a backend software engine that turns the final designs into CAD drawings, and then another backend engine to turn the CAD drawings into machine instructions for specific 3-D printers. However applications will be considered where other means of fabrication are desired such as milling, turning, drilling, burnishing, moulding and others. In one embodiment there is a file transfer protocol for transferring the 3-D computer aided model to a 3D printer. That file transfer protocol may include the step of converting the 3-D computer aided model into a CAD drawing. Furthermore, the file transfer protocol may comprise means for evaluating the project data for compliance with 3D printer specifications and for communicating a conflict if there is non-compliance. In certain embodiments, file transfer protocol may specify the material to be used by the 3D printer for printing of the object, and there may be a configuring step comprising specifying the material to be used by the printer. Similarly, where the 3D printer comprises a laser, the configuring step may comprise specifying the optical power output of the laser, and/or the focal spot size of the laser. The means for evaluating the project data for compliance may include a decryption key, which may be one-time user decryption key arranged to expire after a single use.

In addition, in a ‘calibration process’, after fabrication of a number of examples of shapes modified from a template object using the software application, there is allowed a process where the so-fabricated shapes are scanned using a high resolution 3-D scanner, 3D photogrammetry, or similar (collectively referred to as 3-D scanner in this document). Then a second software program compares the fabricated 3-D shape (as measured by images from the 3-D scanner) to the original CAD drawing outputted by the software application. If there are measurable differences, the software program can use this information and associated automated software to modify the original CAD drawing prior to fabrication such that the originally intended shape is fabricated without or with less deviation from expectations.

Whilst 3D printers are described herein it should be understood that any machine or manufacturing tool capable of turning the 3D project data into a real object can be used.

In another aspect of the invention there is provided a computer-implemented method for interactively designing a 3-D model on a device having a touch-sensitive display. The description in relation to the first and second aspects of the invention apply to this aspect of the invention and visa versa. The method comprises the steps of:

displaying a representation of template 3-D shape of an object for design on a mobile device having touch-sensitive display, at least a part of the object for design having one or more modifiable features;

visually indicating the one or more modifiable features of the image that are available for selection;

selecting a feature for modification by detecting a touch gesture input that comprises the touch of a finger or a pointing device on the relevant part of the image displayed on the touch-sensitive display;

modifying the feature once selected by repeated touch, slide and/or by pinch and expand touch gestures on the relevant part of the image, wherein the touch gestures are used to select one of colour, size, shape, orientation or position of each modifiable feature;

visually displaying the options available for selection in relation to one of colour, size, shape, orientation or position;

updating the representation of the 3-D shape of the object according to the touch gesture input; and displaying the updated representation of the 3D object on the touch-sensitive display.

The step of selecting a feature for modification may comprise a relatively long single touch gesture on the relevant part of the image displayed on the touch-sensitive display. If the feature is modifiable it can change colour. The user may able to quickly identify which features of the object are available for modification and may readily select a feature without having to resort to any complex outside menu function. When one feature is selected a formerly selected feature is usually automatically de-selected.

The method can further comprise the step of deselecting a feature for modification by detecting a touch gesture in an area outside of the image representation of the 3-D shape of the object, the touch gesture comprising the touch of a finger or a pointing device on the touch-sensitive display. This quick deselection allows the user to change their mind rapidly and move onto modifying another part of the object. Furthermore, it makes use of the area outside of the boundary representation of the object, which the user then identifies as a deselection area. The step of deselecting a feature for modification can comprise a relatively long single touch gesture in order to ensure that any mistaken taps on the touch-screen do not unfortunately cease the current design process.

The step of modifying the selected feature can include modification of the physical dimensions of size including the width of a feature in the x-y direction, thickness in the z-direction, radius of the feature and curvature of the feature. These physical dimensions may be important for customising the object to the users specification, or may be the result of aesthetic requirements.

In the step of modifying a selected feature, the touch gesture may be a single tap gesture or a double tap gesture or a sliding of e.g. a feature or an arrow or a pinch and expand touch gesture. Each of these gestures may result in various changes being made to the image on the touch screen. In the step of modifying the selected feature, the touch gesture may be a single touch movement that effects rotation of the image.

The step of visually displaying the options available for selection may comprise a tap gesture that generates a pop-up menu. The pop-up menu can be in the form of a wheel/dial which allows for the rotation through the options for selection. Advantageously, the touch gestures, including those used in the pop-up menu, remain consistent for each modifiable feature. In an embodiment, the consistent features are:
a. for the modification of physical dimensions, the touch gesture is a slide or a pinch and expand gesture. The result of the slide or pinch and expand gesture can be visually displayed, and modifiable with single finger rotation whilst the feature is selected.
b. for the modification of colour, the touch gesture is a single tap gesture that generates a pop-up menu and a single tap gesture for selection of a colour from the menu. The scroll through the selection of colours can be made one at a time. The colour of choice can be selected by single finger rotation of, and selection from the pop-up menu. Optionally, the colour choice indicated in the centre of the pop-up menu matches the current colour selection. Optionally a series of continuous single taps anywhere on the screen will also scroll through the various colour choices.
c. for the modification of shape, the touch gesture is a double tap gesture that generates a pop-up menu and a single tap gesture for selection of a shape from that menu. The shape of choice can be selected by single finger rotation of, and selection from the pop-up menu. Optionally, the option in the centre of the pop-up menu always matches the current shape of the element, whether that element was changed through double taps or through selection on the wheel. Optionally a series of continuous double tap gestures anywhere on the screen will also scroll through the various shape choices.
d. for the modification of orientation or position, the touch gesture is a single touch movement that effects rotation or location of the image.

In another aspect of the invention there is provided a method of 3-D printing a 3-D model designed on a device having a touch-sensitive display, the method comprising the steps of designing the 3-D model in accordance with the method disclosed herein, and printing the updated representation of the 3D object using a 3-D printer.

In another aspect there is provided a computer program product that includes a medium readable by a processor, the medium having stored thereon a set of instructions for designing a 3-D model on a mobile device having a touch-sensitive display, the product comprising:
I. a first sequence of instructions which, when executed by the processor, causes said processor to display a representation of the template 3-D shape of an object for design having one or more modifiable features;
II. a second sequence of instructions which, when executed by the processor, allows a user to modify the modifiable features in accordance with method steps described herein, in order to create project data;
III. a third sequence of instructions which, when executed by the processor, causes said processor to prepare a 3-D computer aided design model based on the project data.

A final sequence of instructions may executed by the processor, which cause said processor to transfer the 3-D computer aided model to a 3D printer.

The invention also provides a device application accessing the program product described in the paragraph above.

### BRIEF DESCRIPTION OF THE DRAWINGS

Embodiments of the invention will now be described with reference to the following drawings which are exemplary only and in which:

FIGS. 1 to 6 are exemplary embodiments of an object and its design using the tool box of the present invention.

### DESCRIPTION OF PREFERRED EMBODIMENTS OF THE INVENTION

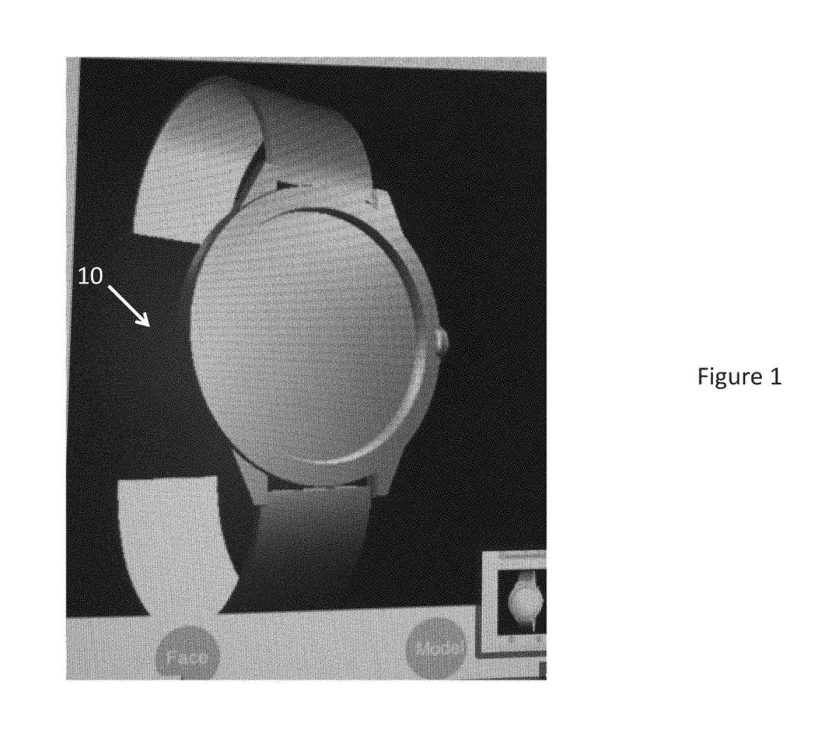

FIG. 1 shows a 3-D shape of a watch 10 on a device having a touch-sensitive display. The watch 10 is shown in grey scale, but it should be understood that it can be any colour. It should also be understood that a watch 10 is shown for exemplary purposes only, but the design tool could be applied to any other 3-D shape of an object. There may be a library of generic template designs e.g. watches. The image of the template 3-D shape for a watch may incorporate a number of watches, some being smaller for e.g. women and some templates being larger for e.g. men. The watch 10, once selected, can have one or more visually indicatable modifiable features that can each be modified by further touch gestures on the touch-sensitive display. Customisation of the watch 10 through modification of the features can be for any reason including functionality, aesthetics, or simple unquantifiable preference for certain features.

In FIG. 1, the watch 10 has one or more visually indicatable modifiable features that are not shown yet because the design tool has not been activated by touch gesture on the screen. Once activated, the features that can be modified will be indicated and, once a feature is selected, it can be modified by further touch gestures on the touch-sensitive display. For the watch 10 the features that can be changed include case, lugs, bezel, crown, face, face numbers and hands. As the features are indicated they can change colour (e.g. to be red in colour) and indicators such as arrows can appear floating around that feature.

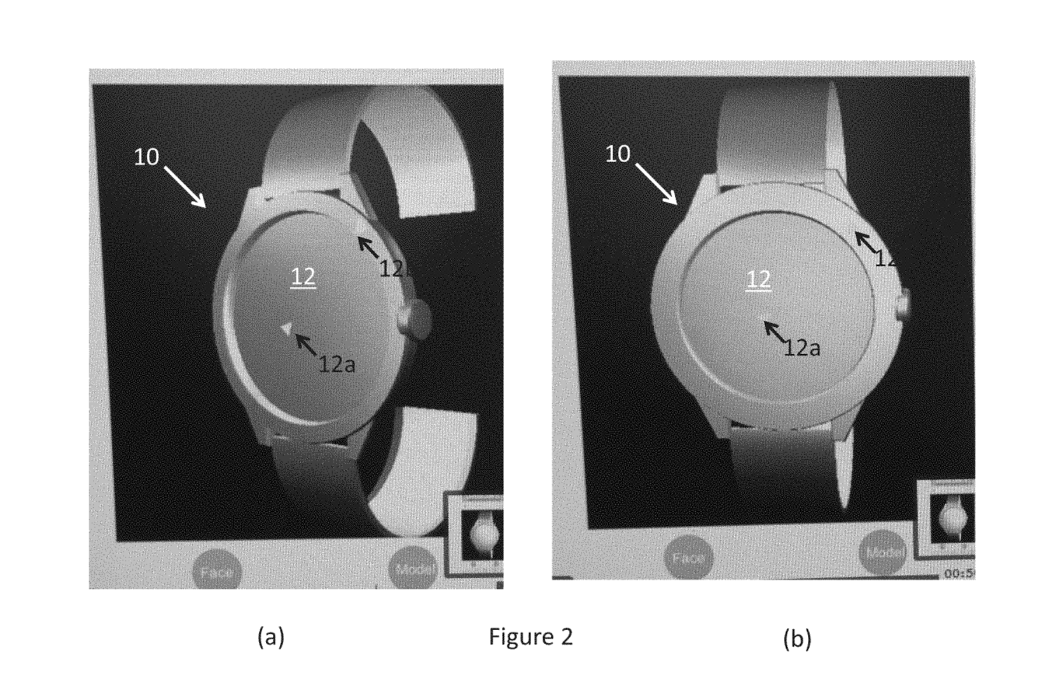

In FIG. 2, a touch gesture on the watch 10 has selected the face 12 as modifiable. A pair of arrows 12a and 12b now appear at the parts of the watch 10 that can be altered by design. Optionally there is only one arrow 12a. In order to alter the size or shape of the face, a pinch and expand or pinch and zoon gesture can be applied to the face by the users finger tips. If there is only one arrow, the gesture can be a slide in the direction indicated by the arrow. As shown in FIG. 2b, a gesture has been made to change the diameter of the face 12 of watch 10 to make it narrower in diameter. The touch gestures on the relevant part of the watch 10 can be used to modify any one of colour, size of any of the x,y,z dimensions, shape, radius, any other size related dimension, shape, orientation with respect to other objects, or position with respect to other objects, of each feature.

The step of selecting a feature such as the face 12 for modification may comprise a relatively long single touch gesture on the face of the watch 10. The user may able to quickly identify which features of the watch 10 are available for modification by tapping on features and seeing if they change colour. The step of deselecting a feature for modification can be by touching an area outside of the image of the watch 10.

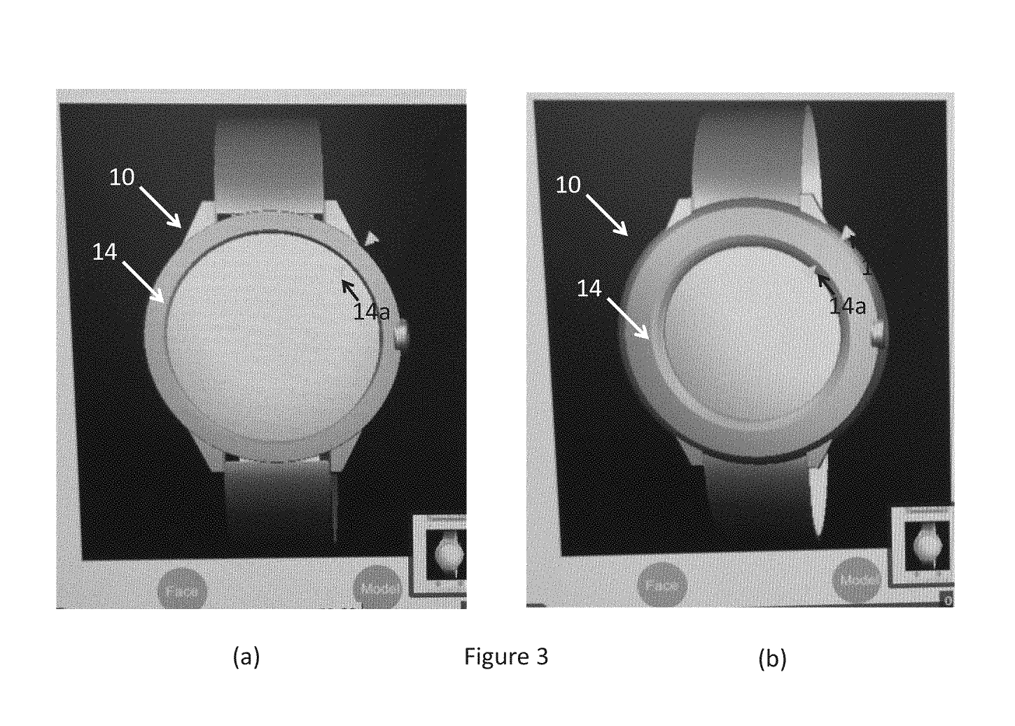

The user can play by trial and error to see what they can modify on the watch 10 and to what upper and lower limits. In FIG. 3, the user has selected the bevel 14 of the watch for modification and now arrows 14a and 14b have appeared. As the user uses a touch gesture, he or she can change the desired design of the bevel to make it appear thicker or thinner in diameter. The number of variations available can appear seamless to the user as the object changes shape.

In the step of modifying a selected feature such as the face 12 or the bevel 14, the touch gesture may be a single tap gesture or a double tap gesture or a slide or a pinch and expand touch gesture. Each of these gestures may result in various changes being made to the image on the touch screen

Once the size and shape of face 12 has been selected, the colour or pattern of the face 12 can be selected. The options for colour can be in a pop-up menu. The pop-up menu can be in the form of a wheel/dial which allows for the rotation through the options for selection.

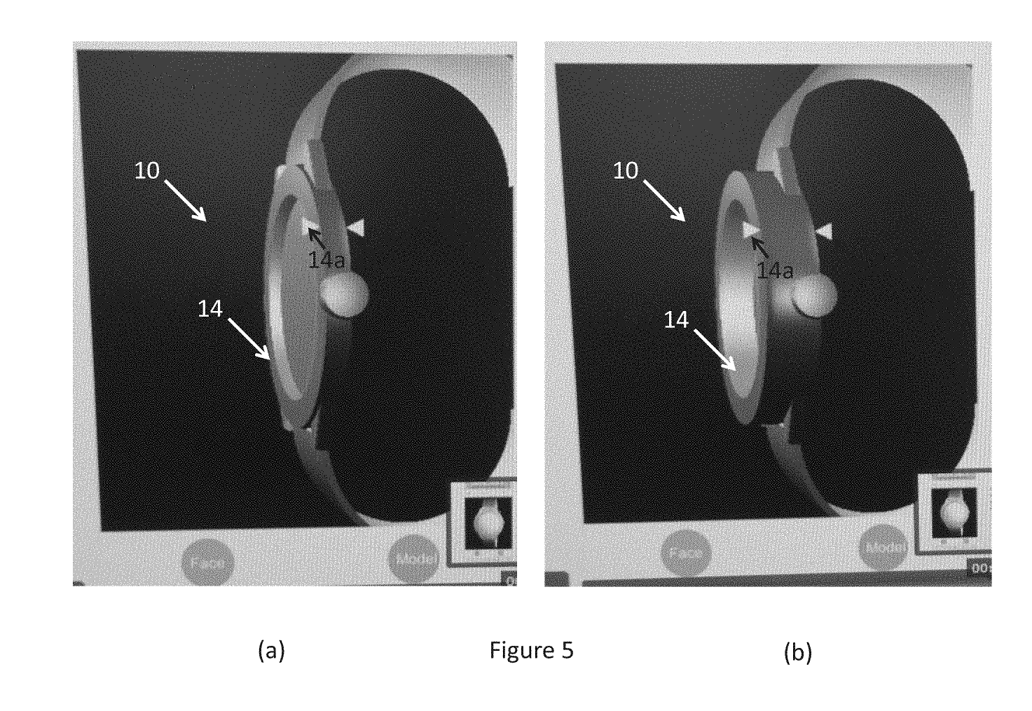

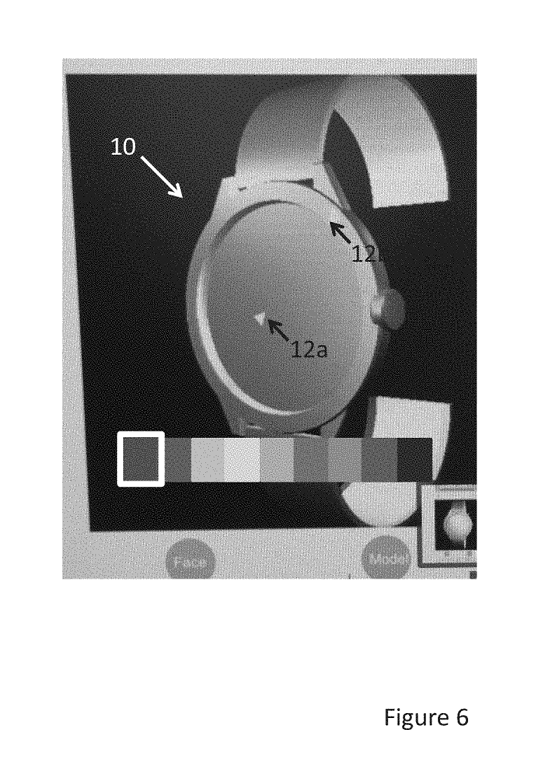

For the watch 10 shown in the Figures, the modification gestures are:
a. for the modification of physical dimensions such as bevel 14 thickness, the touch gesture is a slide or a pinch and expand gesture. The result of the slide or pinch and expand gesture can be visually displayed as shown in e.g. FIG. 5. The watch 10 can be modifiable/purposely rotated with single finger rotation whilst the feature is selected.
b. for the modification of colour, the touch gesture is a single tap gesture that generates a pop-up menu and a single tap gesture for selection of a colour from the menu. The scroll through the selection of colours can be made one at a time. The colour of choice can be selected by single finger rotation of, and selection from the pop-up menu. Optionally, the colour choice indicated in the centre of the pop-up menu matches the current colour selection.
c. for the modification of shape, the touch gesture is a double tap gesture that generates a pop-up menu and a single tap gesture for selection of a shape from that menu. The shape of choice can be selected by single finger rotation of, and selection from the pop-up menu. Optionally, the option in the centre of the pop-up menu always matches the current shape of the element, whether that element was changed through double taps or through selection on the wheel.
d. for the modification of orientation or position, the touch gesture is a single touch movement that effects rotation or location of the image.

During modification of e.g. the face 12, the arrows 12a and 12b (or just 12a) remain indicated on the display so that the user making the change does not have to remember what part of the object they are modifying. Likewise, during modification of the bevel 14, the arrows 14a and 14b (or just 14a) can remain indicated on the display so the user can remember what is being altered even if they are distracted. The arrows can remain indicated until the user selects a different part of the watch 10 for modification. This visual memory aid may help the user to enjoy the design process, since intended changes should take immediate effect on the relevant part of the watch that is changed. In order to assist with this visual memory aid, only one of the modifiable features is displayed at any one moment. This means that if there are two or more features available for modification, only one of them is visually indicated by arrows at any one time.

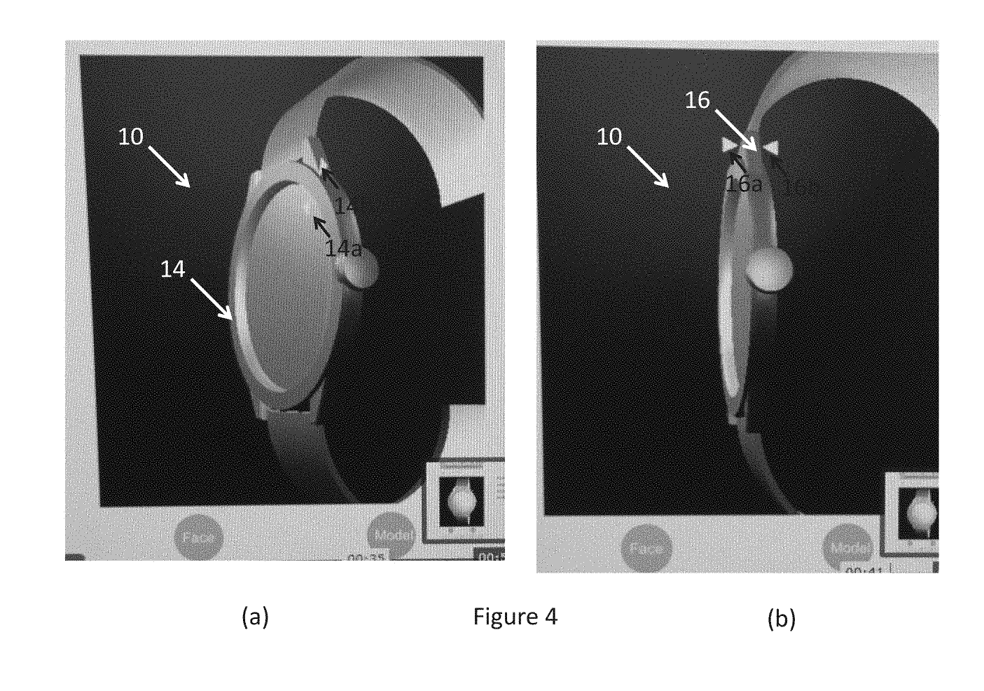

Once selected, that indicated feature can be purposefully varied by touch-driven 3-D rotation of the selected object. FIG. 4 shows the watch when it has been rotated in order that the user can change various features from different viewpoints in order to get the overall gestalt of the design feature. In FIG. 4, the width of the bevel 14 can be selected and the user can see different widths from a different angle (FIG. 4a). Alternatively, the thickness of the lug 16 can be varied. In FIG. 5, there is shown at FIG. 5a that the depth of the bevel 14 can be altered to be thicker (FIG. 5b). All of these changes can be made by the user and should be intuitive as the touch manipulates the image.

To make a selection on a relevant part of watch 10, the user makes touch gestures on the touch-sensitive display. The device then detects the contact with the touch screen and performs the associated command. The device determines if there is movement of the contact touch and tracks the movement of that contact across the touch screen. This is how the dimensions e.g. thickness of certain features such as the bevel 14 can be altered. The device may be able to determine if the contact has been broken (i.e. if the contact has ceased). A selection may be made by making contact with or touching a modifiable feature on the watch 10, for example, with one or more fingers or a stylus. In some embodiments, selection occurs when the user breaks contact with the one or more modifiable features on the watch 10. In some embodiments, the contact may include a gesture, such as one or more taps, one or more swipes (from left to right, right to left, upward and/or downward) and/or a rolling of a finger (from right to left, left to right, upward and/or downward) that has made contact with the device. In some embodiments, inadvertent contact with a part of the watch 10 that cannot be modified, may not select that graphic. The gestures available are limited in number and are consistently used throughout the design process.

Once the user has finished designing the watch, the modification selections are saved as project data. The project data comprises all of the selections made by the user in relation to the modifiable features of the watch 10. The project data may simply be a 3-D design for use in software applications or for photo rendering with no intent with respect to fabrication of an actual watch. Alternatively, there is a backend software engine that turns the final designs into CAD drawings, and then another backend engine to turn the CAD drawings into machine instructions for specific 3-D printers. In one embodiment there is a file transfer protocol for transferring the 3-D computer aided model of the watch 10 to a 3D printer. That file transfer protocol may include the step of converting the 3-D computer aided model into a CAD drawing. Furthermore, the file transfer protocol may comprise means for evaluating the project data for compliance with 3D printer specifications and for communicating a conflict if there is non-compliance i.e. the printer will not be able to print the watch 10 as designed. In certain embodiments, file transfer protocol may specify the material to be used by the 3D printer for printing of the watch 10, and there may be a configuring step comprising specifying the material to be used by the printer.

In the claims which follow, and in the preceding description, except where the context requires otherwise due to express language or necessary implication, the word “comprise” and variations such as “comprises” or “comprising” are used in an inclusive sense, i.e. to specify the presence of the stated features but not to preclude the presence or addition of further features.

1. A computer-aided design toolbox for interactively designing a 3-D model on a device having a touch-sensitive display, said computer-aided design toolbox comprising:
an image of a template 3-D shape incorporating at least one object that can be selected for design by touch-gestures on the touch-sensitive display;
the object, once selected, having one or more visually indicatable modifiable features that can each be modified by further touch gestures on the touch-sensitive display;
wherein the further touch gestures on the relevant part of the image are used to modify one of colour, size of any of the x,y,z dimensions, shape, radius, any other size related dimension, shape, orientation with respect to other objects, or position with respect to other objects of each modifiable feature;
wherein the further touch gestures include single tap, double tap, and multiple tap gestures, slide, pinch and zoom, swipes in any direction, pressure touch, and any other commonly used touch gestures as enabled on a device;
wherein each of the modifiable features is visually displayed on the touch sensitive display during modification so that the user does not have to remember what they are doing; and
wherein only one of the modifiable features is displayed at any moment and wherein the currently displayed modifiable feature can be purposefully varied by touch-driven 3-D rotation of the selected object.

2. A computer-aided design tool for interactively designing a 3-D model on a device having a touch-sensitive display, said computer-aided design tool comprising software program code stored on a server computer and executable by the device accessing the code,
the software program code including:
a. scripting software code for generating an image of template 3-D shape of an object selected for design, the object once selected having one or more modifiable features that can each be selected for modification by touch gesture on the relevant part of the image displayed on the touch-sensitive display;
b. scripting software code for visually indicating which are the one or more modifiable features of the image that are available for selection;
c. scripting software code for modifying each of the modifiable features once selected, the modifications each effected by repeated touch gestures, wherein the touch gestures on the relevant part of the image are used to select one of colour, size of any of the x,y,z dimensions, shape, radius, any other size related dimension, shape, orientation with respect to other objects, or position, with respect to other objects of each modifiable feature;
d. once a modifiable feature is selected, scripting software code for visually displaying the options available for selection in relation to one of colour, size, shape, orientation or position;
wherein the modification selections are saved as project data.

3. The computer-aided design tool according to claim 2, wherein the software program code further includes:
e. 3-D assembly software code for preparing a 3-D computer aided model based on the project data.

4. The computer-aided design tool according to claim 2, wherein the software program code further includes:
f. file transfer protocol for transferring the 3-D computer aided model to a 3D printer, or any other manufacturing tool for making 3-D objects.

5. The computer-aided design tool according to claim 4, wherein file transfer protocol includes the step of converting the 3-D computer aided model into a CAD drawing and/or machine instructions.

6. The computer-aided design tool or toolbox according to claim 1, wherein the 3D object is a watch having modifiable features selected from case, lugs, bezel, crown, face, face numbers and hands.

7. The computer-aided design tool or toolbox according to claim 1, wherein the 3D object is a pair of spectacles having modifiable features selected from arms, frame, bridge, lenses.

8. A computer-implemented method for interactively designing a 3-D model on a device having a touch-sensitive display, the method comprising the steps of:
displaying a representation of template 3-D shape of an object for design on a device having touch-sensitive display, the object for design having one or more modifiable features;
optionally visually indicating the one or more modifiable features of the image that are available for selection;
selecting a feature for modification by detecting a touch gesture input that comprises the touch of a finger or a pointing device on the relevant part of the image displayed on the touch-sensitive display;
modifying the feature once selected by repeated touch gestures on the relevant part of the image, wherein the touch gestures are used to select one of colour, size of any of the x,y,z dimensions, shape, radius, any other size related dimension, shape, orientation with respect to other objects, or position, with respect to other objects of each modifiable feature;
visually displaying the options available for selection in relation to one of colour, size, shape, orientation or position;
wherein each of the modifiable features is visually displayed during modification so that the user does not have to remember what they are doing; and
wherein only one of the modifiable features is displayed at any moment and wherein the modifiable features can be purposefully varied by touch-driven 3-D rotation of the selected object;
updating the representation of the 3-D shape of the object according to the touch gesture input; and displaying the updated representation of the 3D object on the touch-sensitive display.

9. The method according to claim 8, wherein the step of selecting a feature for modification comprises a relatively long single touch gesture on the relevant part of the image displayed on the touch-sensitive display.

10. The method according to claim 8, wherein the method further comprises the step of deselecting a feature for modification by detecting a touch gesture in an area outside of the image representation of the 3-D shape of the object or by the selection of another feature for modification, the touch gesture comprising the touch of a finger or a pointing device on the touch-sensitive display.

11. The method according to claim 8, wherein the step of modifying the selected feature includes modification of the physical dimensions of size including the width of a feature in the x-y direction, thickness in the z-direction, radius of the feature and curvature of the feature.

12. The method according to claim 8, wherein in the step of modifying the selected feature, the touch gesture is selected from a single tap gesture, a double tap gesture, a slide gesture, or a pinch or expand touch gesture.

13. The method according to claim 8, wherein the step of visually displaying the options available for selection comprises a tap gesture that generates a pop-up menu, preferably in the form of a wheel/dial which allows for the rotation through the options for selection.

14. The method according to claim 8, wherein in the step of modifying the selected feature, the touch gestures remains consistent for each modifiable feature:
a. for the modification of physical dimensions, the touch gesture is a slide or pinch and expand gesture wherein the physical dimension that can be modified with the two finger pinch or expand gesture is visually displayed and modifiable with single finger rotation whilst the element is selected;
b. for the modification of colour, the touch gesture is a single tap gesture that generates a pop-up menu and a single tap gesture for selection of a colour from the menu;
c. for the modification of shape, the touch gesture is a double tap gesture that generates a pop-up menu and a single tap gesture for selection of a shape from that menu;
d. for the modification of orientation or position, the touch gesture is a single touch movement that effects rotation or location of the image.

15. The method according to claim 14, further comprising the step of generating the template 3-D shape of the object for design.

16. The method according to claim 14, wherein the template 3-D shape of the object generated for design is selected from a watch or spectacles.

17. The method according to claim 14, wherein the method further comprising the steps of
transferring the updated representation of the 3D object on the touch-sensitive display to a 3D printer or other or any other manufacturing tool for making 3-D objects.

18. A method of 3-D printing a 3-D model designed on a device having a touch-sensitive display, the method comprising the steps of:
designing the 3-D model in accordance with the method of claim 17, and
printing the updated representation of the 3D object using a 3-D printer or any other manufacturing tool for making 3-D objects.

19. The method of claim 18, further comprising the steps of:
scanning the 3-D obtained for the printing step;
detecting and then correcting any discrepancies between the intended shape of the 3-D object and the printed 3-D object; and
printing the updated representation of the 3D object using a 3-D printer or any other manufacturing tool for making 3-D objects.

20. A computer program product that includes a medium readable by a processor, the medium having stored thereon a set of instructions for designing a 3-D model on a device having a touch-sensitive display, the product comprising:
I. a first sequence of instructions which, when executed by the processor, causes said processor to display a representation of the template 3-D shape of an object for design having one or more modifiable features;
II. a second sequence of instructions which, when executed by the processor, allows a user to modify the modifiable features in accordance with method steps of claim 8, in order to create project data;
III. a third sequence of instructions which, when executed by the processor, causes said processor to prepare a 3-D computer aided design model based on the project data.
